(19) United States
(12) Patent Application Publication
(10) Pub. No.: US 2020/0195115 A1
(43) Pub. Date: Jun. 18, 2020

(54) LINEAR VIBRATION MOTOR

(71) Applicant: AAC Acoustic Technologies (Shenzhen) Co., Ltd., Shenzhen (CN)

(72) Inventor: Tao Zhang, Shenzhen (CN)

(21) Appl. No.: 16/699,148

(22) Filed: Nov. 29, 2019

(30) Foreign Application Priority Data
Dec. 17, 2018 (CN) 201822119164.2

(51) Int. Cl. H02K 33/16

(52) U.S. Cl. CPC H02K 33/16

(57) ABSTRACT

The present disclosure provides a linear vibration motor, which includes a shell with an accommodating space, a vibration unit accommodated in the accommodating space, an elastic component suspending the vibration unit in the accommodating space and a driving unit driving the vibration unit to vibrate and fixed to the shell, wherein the vibration unit includes a counterweight with a middle through hole, a magnet yoke assembled in the through hole and a permanent magnet attached and fixed to the magnet yoke, the vibration unit further includes baffles covered at two ends of the through hole, and an orthographic projection of the permanent magnet are along a perpendicular vibration direction is at least partially overlapped with the baffles. Compared with the prior art, the linear vibration motor provided by the present disclosure has stable structure and strong reliability.

### TECHNICAL FIELD

The present disclosure relates to the field of electroacoustic conversion, and more particularly, to a linear vibration motor.

### BACKGROUND

With the rapid development of electronic technologies, portable consumer electronics, such as mobile phones, handheld game consoles, navigation devices or handheld multimedia entertainment devices, are more and more popular with people. These electronics generally use linear motors for system feedback, such as incoming call prompt, information prompt, navigation prompt, vibration feedback of the game consoles, etc.

The linear vibration motor of the related art includes a shell with an accommodating space, a vibration unit accommodated in the accommodating space, an elastic component for suspending the vibration unit in the accommodating space, and a driving unit for driving the vibration unit to vibrate and fixed to the shell.

However, in drop testing, the structure of the vibration unit of the linear vibration motor in the related art is not stable enough, and drop events occur from time to time. In particular, the permanent magnets are easy to fall off in the drop testing, thus reducing the yield and reliability of the linear vibration motor.

Therefore, it is necessary to provide a novel linear vibration motor to solve the above-mentioned problems.

### BRIEF DESCRIPTION OF THE DRAWINGS

In order to illustrate the technical solutions in the embodiments of the present disclosure more clearly, the drawings used in the description of the embodiments will be briefly described below. Obviously, the drawings in the following description merely are some embodiments of the present disclosure. Those of ordinary skills in the art can also obtain other drawings according to these drawings without going through any creative work, wherein:

FIG. 1 is a schematic perspective view of a linear vibration motor provided by the present disclosure;

FIG. 2 is a schematic perspective view of the linear vibration motor shown in FIG. 1 after removing a top cover;

FIG. 3 is an 3D exploded view of the linear vibration motor shown in FIG. 1;

FIG. 4 is a sectional view of the linear vibration motor shown in FIG. 1 along a line A-A; and

FIG. 5 is a partial 3D exploded view of the linear vibration motor of the present disclosure.

### DETAILED DESCRIPTION

The following clearly and completely describes the technical solutions in the embodiments of the present disclosure with reference to the accompanying drawings in the embodiments of the present disclosure. Apparently, the described embodiments are merely some but not all of the embodiments of the present disclosure. Based on the embodiments of the present disclosure, all other embodiments obtained by those of ordinary skills in the art without going through any creative work shall fall within the scope of protection of the present disclosure.

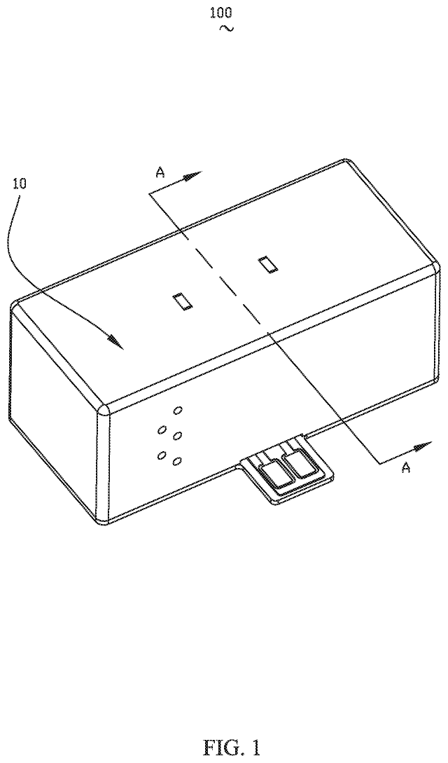

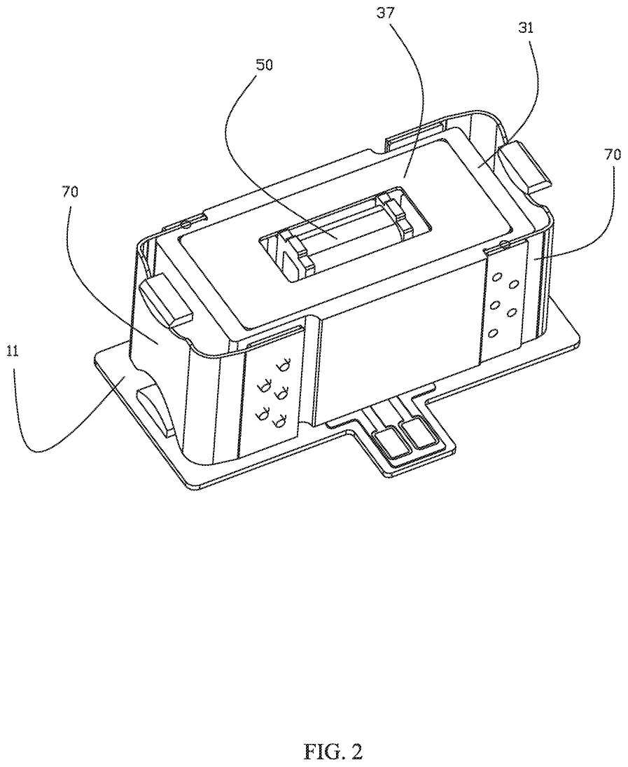

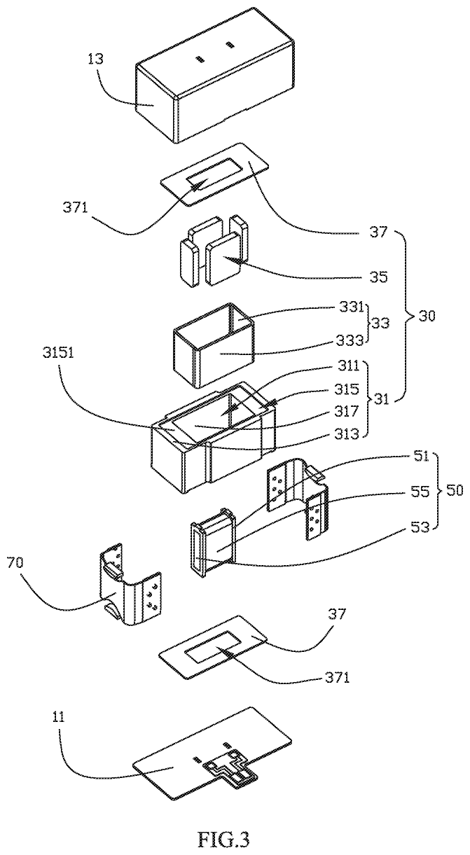

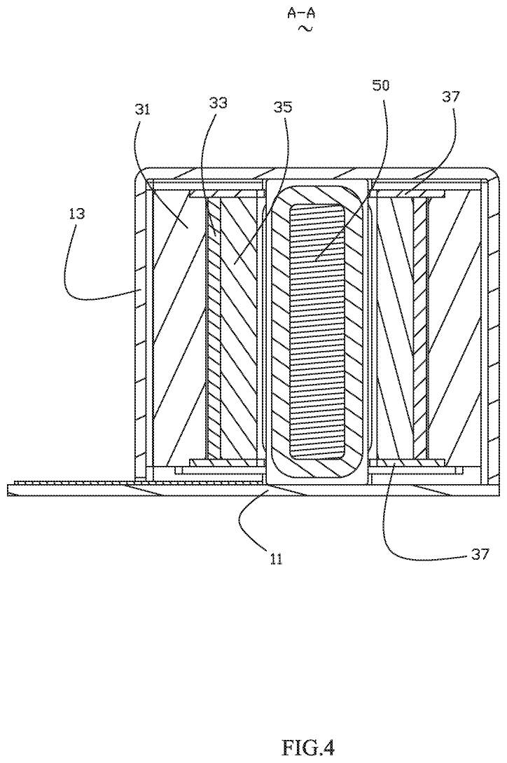

Referring to FIG. 1 to FIG. 5, the linear vibration motor 100 includes a shell 10 with an accommodating space, a vibration unit 30 accommodated in the accommodating space, an elastic component 70 for suspending the vibration unit 30 in the accommodating space, and a driving unit 50 for driving the vibration unit 30 to vibrate and fixed to the shell 10.

The shell 10 includes a base plate 11 and a top cover 13 assembled with the base plate 11 to form the accommodating space.

In the embodiment, the vibration unit 30 includes a counterweight 31 with a middle through hole 311, a magnet yoke 33 assembled in the through hole 311, a permanent magnet 35 attached and fixed to the magnet yoke 33, and baffles 37 covered at two ends of the through hole 311. The driving unit 50 is located in a center of the magnet yoke 33, and an orthographic projection of the permanent magnet 35 that is along a vertical vibration direction is at least partially overlapped with the baffles 37. In other embodiments, the vibration unit 30 may not include the magnet yoke 33, and the permanent magnet 35 may be directly fixed to the counterweight 31.

The counterweight 31 further includes end faces 313 located at the two ends of the through hole 311, annular grooves 315 recessed from the end faces 313 along the vertical vibration direction, and an inner side wall 317 that defines the through hole 311. To be specific, the magnet yoke 33 is fixed to the inner side wall 317, the permanent magnet 35 is fixed to the magnet yoke 33, and the driving unit 50 is inserted into the through hole 311 and separately disposed from the permanent magnet 35.

The annular grooves 315 are communicated with the through hole 311, and the baffles 37 are clamped and fixed in the annular grooves 315. By arranging the baffles 37, the structure stability and reliability of the magnet yoke 33 and the plurality of permanent magnets 35 are strengthened, so that the magnet yoke 33 and the permanent magnets 35 are not dropped during vibration, and the product yield of the linear vibration motor 100 is ensured.

The annular groove 315 includes a bottom groove surface 3151. Preferably, in order to further strengthen the structure stability of the magnet yoke 33 and the permanent magnet 35, in the embodiment, a height of the magnet yoke 33 and a height of the permanent magnet 35 along the vertical vibration direction are equal to a vertical pitch between the two bottom groove surfaces 3151.

Preferably, the baffles 37 are glued to the bottom groove surface 3151, and the baffles 37 are abutted against the magnet yoke 33 and the permanent magnet 35, thus further enhancing the structure stability of the permanent magnet.

The magnet yoke 33 is annular. The magnet yoke 33 includes first side walls 331 facing the permanent magnet 35 and arranged oppositely, and second side walls 333 connected with the first side walls 331 and arranged oppositely. Four permanent magnets 35 are provided. To be specific, the first side walls 331 and the second side walls 333 are fixedly provided with one permanent magnet 35 respectively. In other embodiments, two permanent magnets 35 may be provided as well.

The driving unit 50 includes a pole shoe 51 fixed to the shell, a pole core 53 fixed to the pole shoe 51, and a coil 55 wound and fixed to the pole core 53. Two ends of the driving unit 50 are respectively connected to the base plate 11 and the top cover 13 along a penetrating direction of the through hole 311. Therefore, a center of each baffle 37 is provided with an escape hole 371 avoiding the pole shoe 51 and corresponding to the through hole 11, and one end of the pole shoe 51 is fixed to the top cover 13 and the other end of the pole shoe 51 is fixed to the base plate 11 along the vertical vibration direction.

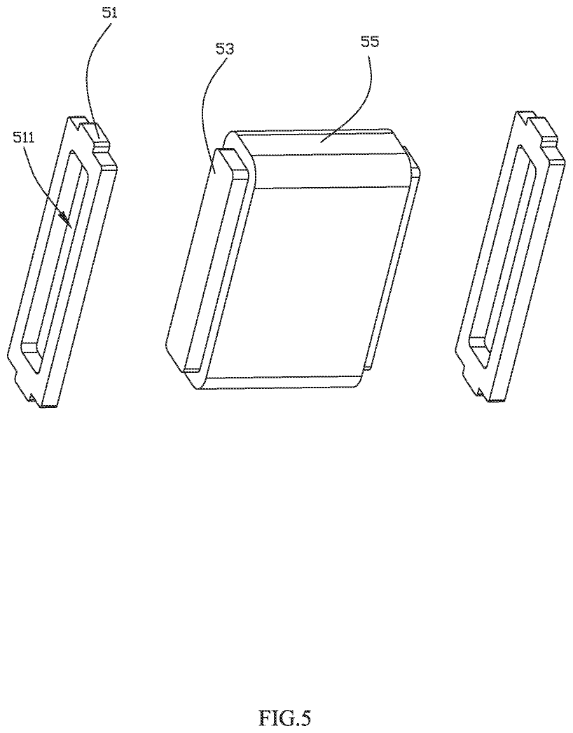

Referring to FIG. 5 for details, the pole shoe 51 includes a fixing hole 511 penetrating along the vibration direction, two pole shoes 51 are provided, and two ends of the pole core 53 are respectively clamped and fixed to the fixing holes 511.

Compared with the related art, the linear vibration motor 100 according to the present disclosure strengthens the structure of the linear vibration motor 100 by arranging the baffles 37 in the vibration unit 30, and plays a role of protecting the permanent magnet 35 in a drop testing, so that the linear vibration motor 100 has stable structure and strong reliability.

The description above merely is the embodiments of the present disclosure, and it should be noted that those of ordinary skills in the art may make improvements without departing from the concept of the present disclosure, and all these improvements shall belong to the scope of protection of the present disclosure.

What is claimed is:

1. A linear vibration motor, comprising a shell with an accommodating space, a vibration unit accommodated in the accommodating space, an elastic component suspending the vibration unit in the accommodating space, and a driving unit driving the vibration unit to vibrate and fixed to the shell, wherein the vibration unit comprises a counterweight with a middle through hole, a magnet yoke assembled in the through hole and a permanent magnet attached and fixed to the magnet yoke, the vibration unit further comprises baffles covered at two ends of the through hole, and an orthographic projection of the permanent magnet that is along a vertical vibration direction is at least partially overlapped with the baffles.

2. The linear vibration motor according to claim 1, wherein the counterweight comprises end faces located at the two ends of the through hole and annular grooves recessed from the end faces along the vertical vibration direction, the annular grooves are communicated with the through hole, and the baffles are clamped and fixed in the annular grooves.

3. The linear vibration motor according to claim 2, wherein the annular groove comprises a bottom groove surface, and a height of the magnet yoke and a height of the permanent magnet along the vertical vibration direction are equal to a vertical pitch between the two bottom groove surfaces.

4. The linear vibration motor according to claim 3, wherein the baffles are glued to the bottom groove surface, and the baffle are abutted against the magnet yoke and the permanent magnet.

5. The linear vibration motor according to claim 1, wherein the counterweight further comprises an inside wall that defines the through hole, the magnet yoke is fixed to the inside wall, the permanent magnet is fixed to the magnet yoke, and the driving unit is inserted into the through hole and separately disposed from the permanent magnet.

6. The linear vibration motor according to claim 5, wherein the magnet yoke is annular and comprises first side walls facing the permanent magnet and arranged oppositely, and second side walls connected with the first side walls and arranged oppositely, four permanent magnets are provided, and the first side walls and the second side walls are fixedly provided with one permanent magnet respectively.

7. The linear vibration motor according to claim 1, wherein the driving unit comprises a pole shoe fixed to the shell, a pole core fixed to the pole shoe and a coil wound and fixed to the pole core.

8. The linear vibration motor according to claim 7, wherein the shell comprises a base plate and a top cover assembled with the base plate to form the accommodating space, each of the baffles is provided with an escape hole for avoiding the pole shoe and corresponding to the through hole, and one end of the pole shoe is fixed to the top cover and the other end of the pole shoe is fixed to the base plate along the vertical vibration direction.

9. The linear vibration motor according to claim 8, wherein the pole shoe comprises a fixing hole penetrating along the vibration direction, two pole shoes are provided, and both ends of the pole core are respectively clamped and fixed to the fixing holes.
